(19) United States
(12) Patent Application Publication
(10) Pub. No.: US 2023/0314605 A1
(43) Pub. Date: Oct. 5, 2023

(54) MULTIMODE TRANSMISSION DISTRIBUTED OPTICAL FIBER SENSOR

(71) Applicant: California Institute of Technology, Pasadena, CA (US)

(72) Inventors: Luis Costa, Pasadena, CA (US); Alireza Marandi, Pasadena, CA (US); Zhongwen Zhan, Pasadena, CA (US)

(73) Assignee: California Institute of Technology, Pasadena, CA (US)

(21) Appl. No.: 18/191,949

(22) Filed: Mar. 29, 2023

Related U.S. Application Data
(60) Provisional application No. 63/324,999, filed on Mar. 29, 2022.

(51) Int. Cl. G01S 17/02; G01S 17/89; G01S 7/481

(52) U.S. Cl. CPC G01S 17/02; G01S 17/89; G01S 7/4818

(57) ABSTRACT

A sensor system including an optical fiber comprising a first spatial channel and a second spatial channel, wherein the spatial channels are coupled and electromagnetic radiation propagates with different group velocities in each of the spatial channels. The sensor system further includes a source inputting the electromagnetic radiation into the first spatial channel at an input; and a detection system coupled to an output of the fiber, the detection system including a detector detecting transmission of the electromagnetic radiation coupled into the second spatial channel at different positions along the fiber between the input to the output, and generating a signal in response thereto; and a computer processing the signal to obtain a localized measurement of a physical parameter at one or more of the different positions along the fiber.

### CROSS REFERENCE TO RELATED APPLICATIONS

This application claims the benefit under 35 U.S.C. Section 119(e) of co-pending and commonly-assigned U.S. provisional patent application Ser. No. 63/324,999, filed Mar. 29, 2022 by Luis Costa, Alireza Marandi, and Zhongwen Zhan, entitled “MULTIMODE TRANSMISSION DISTRIBUTED OPTICAL FIBER SENSOR,” CIT. CIT-8805-P, which application is incorporated by reference herein.

### BACKGROUND OF THE INVENTION

### 1. Field of the Invention

The present invention relates to methods and systems for sensing using an optical fiber.

### 2. Description of the Related Art

The deep ocean floor is a particularly relevant example of an environment where traditional geophysical sensing equipment is sparse, costly, and often temporary [18], and where the existence of transoceanic telecommunication fibers presents an exceptional opportunity for fiber-based sensing. So far, attempts at exploring transoceanic fibers for sensing have remained limited in their localization capabilities, either unable to discriminate the origin of each strain contribution [19][21], or able to localize only a few dominant perturbations along the cable through bi-directional measurements [19]. Fully distributed acoustic sensing techniques, on the other hand, struggle to meet the criteria for sensing in such longhaul cables, as their fundamental reliance on intrinsic backscattering for localization imposes a barrier to massive range enhancement via in-line amplification (owing to the presence of optical isolators in the amplifiers), and the probe pulse's characteristically high peak powers (˜200 mW) render these techniques incompatible with co-propagating data channels [14], [22], which is especially limiting given the lack of abundant fiber strands in transoceanic cables. What is needed are improved methods for sensing using optical fibers. The present disclosure satisfies this need.

### SUMMARY OF THE INVENTION

Simultaneously sensing and resolving the position of measurands along an optical fiber enables numerous opportunities, especially for application in environments where massive sensor deployment is not feasible. Despite significant progress in techniques based on round-trip time-of-flight measurements, the need for bidirectional propagation imposes fundamental barriers to their deployment in fiber communication links w containing non-reciprocal elements. Illustrative embodiments of the present invention disclosed herein break this barrier by introducing a position-resolved sensing technique based on the interference of two weakly-coupled non-degenerate modes of an optical fiber, as they walk-off through each other. This mode-walk-off interferometry is used to experimentally measure and localize physical changes to the fiber under test (e.g., axial strain and temperature) without the typical requirement of round-trip time-of-flight measurements. The unidirectional propagation requirement of this method makes it compatible with fiber links incorporating non-reciprocal elements, uncovering a path for multiple sensing applications, including but not limited to, ultra-long range distributed sensing in amplified space-division-multiplexed telecommunication links.

Example methods, devices and systems according to embodiments described herein include, but are not limited to, the following:
1. A sensor system, comprising:
an optical fiber comprising a first spatial channel and a second spatial channel, wherein the spatial channels are coupled and electromagnetic radiation propagates with different group velocities in each of the spatial channels;
a source inputting the electromagnetic radiation into the first spatial channel at an input; and
a detection system coupled to an output of the fiber, the detection system comprising:
   a detector detecting a transmission, from the input to the output, of the electromagnetic radiation coupled into the second spatial channel at different positions along the fiber between the input to the output, and generating a signal in response thereto; and
   a computer processing the signal to obtain a localized measurement of a physical parameter at one or more of the different positions along the fiber.
2. The sensor system of example1, wherein the localized measurement comprises a quantitative measurement, the fiber comprises a step-index fiber, a graded-index few-mode fiber, a heterogeneous multicore fiber, or a coupled-core multicore fiber, and the spatial channels comprise co-propagating modes or cores having the different group velocities for the electromagnetic radiation.
3. The sensor system of example1 comprising a plurality of the fibers of example1 distributed in a network, wherein the spatial channels comprise spatial and wavelength multiplexed data channels.
4. The sensor system of example1, wherein the physical parameter comprises strain, temperature, birefringence, or refractive index of the fiber.
5. The sensor system of example1, further comprising a polarization synthesizer, wherein the source inputs the electromagnetic radiation via the polarization synthesizer and the physical parameter comprises at least one of a circular component or a linear component of birefringence.
6. The sensor of example1, wherein the computer:
identifies, in the signal, changes in a coupling strength between the spatial channels as a function of the different positions, and
processes the changes in the coupling strength to obtain the localized measurement of the physical parameter comprising at least one of transverse stress, a bending, or transverse pressure applied to the fiber.
7. The sensor system of example1, wherein the fiber is coupled to one or more in line amplifiers amplifying the electromagnetic radiation at one or more of different positions along a length of the fiber, so that the detection system measures the interference with increased signal to noise.
8. A telecommunications link comprising the sensor system of example1, comprising the fiber coupled to one or more non-reciprocal elements, wherein the non-reciprocal elements prevent backward propagation of the electromagnetic radiation in the fiber.
9. The sensor system of example1, wherein the computer:
processes the signal by:
sampling at a sampling rate to obtain sampled data, and
identifying interference or a change in coupling strength in the sampled data, the interference resulting from the electromagnetic radiation coupled into the second spatial channel at different positions along the fiber; and
wherein the sampling rate is selected independently of the round-trip time for propagation of the electromagnetic radiation between the input and the output.
10. The sensor system of example1, wherein:
the detector comprises balanced detectors detecting a local oscillator comprising the electromagnetic radiation outputted from the first spatial channel, and the electromagnetic radiation outputted from the second spatial channel, wherein the local oscillator and the electromagnetic radiation in the second mode are automatically path length matched by virtue of being carried in the same fiber and common mode noise is rejected using the local oscillator.
11. The sensor system of example1, wherein:
the source outputs the electromagnetic radiation comprising multiple center frequencies, and
the computer identifies the interference at each of the different positions by:
   partitioning the signal into a plurality of sections, each of the sections comprising a frequency response of the fiber to a different one of the center frequencies, and
   associating each of the frequency responses to a different one of the positions along a length the fiber; and
the computer obtains the localized measurement by comparing each of one or more of the frequency responses to a previously acquired reference.
12. The sensor of example11, wherein the comparing obtains a frequency detuning with respect to the reference and the computer calculates the localized measurement from the frequency detuning.
13. The sensor system of example11, further comprising an auxiliary interferometer coupled to the source, wherein:
the source inputs the electromagnetic radiation comprising a linear frequency sweep comprising the center frequencies to the auxiliary interferometer and the fiber;
the auxiliary interferometer outputs an auxiliary signal and the computer uses the auxiliary signal to determine a nonlinearity of the frequency sweep; and
the computer adjusts the frequency responses to account for the nonlinearity.
14. The sensor system of example11, wherein the source outputs chirped pulses comprising the plurality of center frequencies or a plurality of shots of the electromagnetic radiation each comprising a different one of the center frequencies.
15. The sensor system of example1, wherein the computer:
processes the signal so as to identify one or more phase differences in the signal resulting from interference between the electromagnetic radiation coupled into the second spatial channel at the different positions of strong coupling between the spatial channels, and
processes the phase differences to obtain the localized measurements.
16. The sensor system of example 15, wherein the physical parameters comprise inter-mode coupling at the different positions of components coupled to the fiber, the different components comprising at least one of an amplification stage, a splice, a connector, a multiplexer, or a demultiplexer.
17. The sensor system of example1, further comprising a second detection system measuring backwards propagation of the electromagnetic radiation resulting from reflection or backscattering events of the electromagnetic radiation towards the input, wherein the computer determines the physical parameters with denser spatial sampling in-between the reflection or backscattering events.
18. The sensor system of example1, further comprising a second detection system measuring backwards propagation of the electromagnetic radiation resulting from reflection or backscattering events towards the input, wherein the computer uses a simultaneous measurement of the backwards propagation from the second detection system to isolate a contribution of the physical parameter comprising a circular component of the birefringence vector.
19. The sensor system of example1, wherein:
the fiber transmits the electromagnetic radiation modulated according to a space-division multiplexing scheme, and
the computer:
   processes the signal so as to identify changes in a coupling strength between the spatial channels as a function of the different positions, and
   processes the changes in the coupling strength to obtain the localized measurement of the physical parameter.
20. The sensor system of example1, wherein the computer compares changes in the interference and the coupling strength between the spatial channels comprising multiple higher order copropagating modes of the electromagnetic radiation, so as to obtain the local measurements of a plurality of the physical parameters, resulting from a perturbation of the fiber, with reduced cross-sensitivity between parameters.
21. A method of sensing, comprising:
inputting electromagnetic radiation into a first spatial channel of an optical fiber comprising the first spatial channel and a second spatial channel, wherein the spatial channels are weakly coupled and electromagnetic radiation propagates with different group velocities in each of the spatial channels;
detecting a transmission, from the input to the output, of the electromagnetic radiation coupled into the second spatial channel at different positions along the fiber between the input to the output, and generating a signal in response thereto; and
processing the signal to obtain a localized measurement of a physical parameter at one or more of the different positions along the fiber.

### BRIEF DESCRIPTION OF THE DRAWINGS

Referring now to the drawings in which like reference numbers represent corresponding parts throughout:

FIGS. 1A-1E. Principle of transmission-only distributed sensing. FIG. 1A. Light is launched as the fundamental mode of a fiber carrying at least a pair of non-degenerate modes, of different phase and group velocities. FIG. 1B. Weak distributed coupling (of coupling strength K) converts light from the injected mode to higher order modes as it propagates. The difference in group velocities leads to an effective walk-off between previously coupled light and the injected mode beam (FIG. 1D), such that the point of coupling is mapped to a specific time-instant at the output. FIG. 1C. The difference in group velocity broadens the higher-order mode output, and the difference in phase velocities leads to interference between the newly coupled and previously coupled light FIG. 1E, generating a noise-like broad optical trace at each higher mode output: each time-instant of the OAM_{±1} stores the local interference resulting from light traversing two different optical paths.

FIG. 2A-2D. FIG. 2A. Depiction of an interrogation setup. FIG. 2B. Recovered impulse response obtained from one sub-sweep, (for a single mode and polarization) using swept-wavelength interferometry. Amplitude is normalized to the initial peak at time delay 0, occurring from imperfect demultiplexing at the output. FIG. 2C. Fiber Under Test (FUT) configuration for the multipoint temperature measurement and d. for the single-point strain measurement.

FIG. 3. Experimental setup. PBS: Polarization Beam Splitter; BPD: Balanced Photodetector; DAQ: Data Acquisition. The laser source used was a Toptica CTL 1050, operating at center wavelength 1064 nm and swept by driving the internal stepper motor with a 0.2 Hz sine wave. A portion (10%) of the laser output power is diverted into an imbalanced Mach-Zehnder interferometer used for compensation of sweep nonlinearity. The remaining 90%(˜12 dBm) is launched into the FUT. The laser is swept at an average rate of 1.63 THz/s (6.19 nm/s) over each acquisition (0.83 s around the point of highest linearity of the positive slope of the sinusoidal modulation).

FIGS. 4A-4C. Method for single sweep interrogation of the fiber. FIG. 4A. The raw data obtained from a subsweep is split into shorter time sections. Each is then processed to obtain the optical trace, which is interpolated to a fixed number of samples, and is then stored in a matrix for optical traces. Each column of this matrix corresponds to one optical trace obtained for a given center frequency detuning, while each row stores the frequency response of the effective interferometer formed at a specific point in the fiber. FIG. 4B Example optical trace. FIG. 4C Example trace matrix.

FIG. 5. Signal processing stack for an acquisition. Light blue marks signals or matrices and white marks processing steps.

FIGS. 6A-6B. Multipoint temperature measurement. FIG. 6A. The full fiber temperature profile. FIG. 6B. Close up of the perturbation region. Dashed regions mark sections to calculate the root-mean-square temperature shift to observe the spatial resolution (bottom subplot). Right subplot shows the temperature measurement at the point of highest perturbation amplitude for each hotspot over time.

FIGS. 7A-7B. Strain measurement. FIG. 7A is the full fiber strain profile. FIG. 7B. Close up of the perturbation region. The subplot shows the strain signal at PZT section of fiber (blue) and of an undisturbed position in the fiber (red), for comparison. Green shows the waveform applied to the piezoelectric fiber stretcher.

FIG. 8. Incoherent measurements, obtained by averaging all optical traces obtained from all subsweeps, for a given acquisition. Top: measured relative coupling strength of the fiber, normalized to the median coupling strength. At positions where the fiber is coiled, tightly bent, or suffers micro-bends from poor spooling, stronger coupling strength is observed. Bottom: measurements of coupling strength changes over time, for the same data as the strain acquisition.

FIG. 9. Flowchart illustrating a method of making a sensor system.

FIG. 10. Flowchart illustrating a method of operating a sensor system.

FIG. 11. Example computer environment for performing methods described herein.

FIG. 12. Example network environment for performing methods described herein.

FIG. 13 illustrates an example telecommunications network including in line amplifiers, non reciprocal elements, and a hybrid detection scheme measuring forward transmission and backscattering.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized, and structural changes may be made without departing from the scope of the present invention.

Technical Description

A sensor according to embodiments described herein outputs measurements of one more physical parameters along the length of multimode or multicore optical fibers, with access to the information occurring at different points in the fiber. The measurements are obtained from only unidirectional propagation of light in the fiber. Embodiments of the sensor system can be implemented in any pair of fibers that carry two different modes, supermodes or cores (spatial channels) that propagate with different group velocities and that experience weak coupling between themselves.

Example fibers include, but are not limited to step-index and graded-index few-mode fibers, heterogeneous multicore fibers, and coupled-core multicore fibers that exhibit different group velocities between different co-propagating modes/cores/super modes.

Distributed sensing can be achieved in fibers carrying other or co-propagating spatial and wavelength multiplexed data channels.

Localized, quantitative measurements of multiple physical parameters and fiber properties can be recovered from the local interference produced from the local coupling of forward-propagating modes (i.e., a using unidirectional measurement).

Example physical parameters that can be measured include, but are not limited to, strain changes, temperature changes, refractive index changes, pressure changes, stress changes, and birefringence.

### First Example [54]

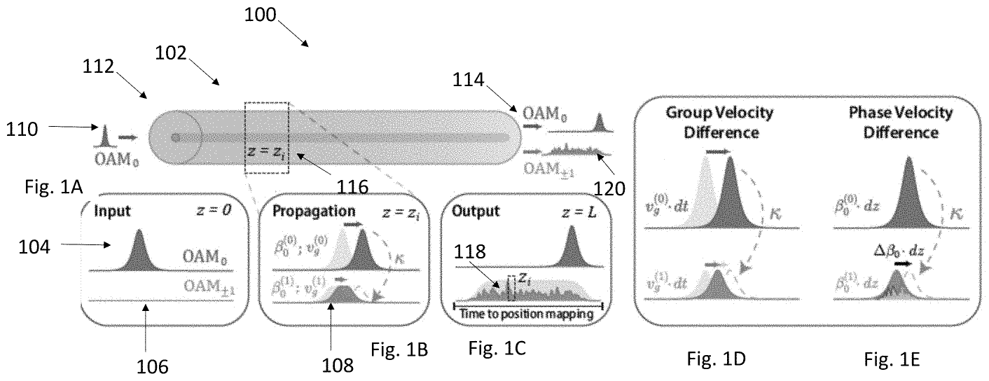

FIG. 1 illustrates sensing system wherein a pulse of light is injected into the fundamental mode (OAM₀, in the Optical Angular Momentum mode basis [44]) of a two-mode fiber. After coupling to a higher-order mode, the light experiences both a different propagation constant, [symbol] , and a different group velocity, [symbol] (where [symbol] is the topological charge of the corresponding OAM mode) for the remaining length of fiber, enabling the estimation of a measurand amplitude and the localization of perturbations along the fiber. Localization information is encoded in time as a result of the difference in group velocities between mode groups, since light coupled from the fundamental mode at each position is displaced from pre-existing light in the higher order modes. The fiber output, the OAM_{±1} signal, comprises a broad temporal envelope, each time instant mapping to a specific position in the fiber.

The position information can therefore be recovered via a differential time-of-flight measurement on the higher order mode output. Specifically, light coupled to a higher order mode at position z in the fiber will, at the fiber output, exhibit a temporal walkoff relative to light that remained uncoupled proportional to the remaining fiber length (L_{FUT}−z) and the differential mode group delay (DGD=1/v_{g}^{(±1)}−1/v_{g}⁽⁰⁾) between the two mode groups

Δt(z)=DGD(L_{FUT}−z) (1)

Traditional backscattering-based methods in conventional distributed techniques rely on roundtrip time-of-flight for position discrimination. The present invention, on the other hand, can obtain localized position measurements with transmission only signals. The differential nature of the measure, however, yields a temporally compressed optical trace (i.e., the obtained impulse response obtained for a given pair of input/output modes) compared to traditional roundtrip measurements

$$( by a factor CF \approx - \frac{2 {v}_{g}^{( 0 )}}{Δ {v}_{g}} ) .$$

A narrower optical trace implies a natural penalty to the spatial resolution (and potentially increases analog-to-digital conversion bandwidth requirements), but relaxes the fundamental limits of acquisition rate by the same amount. Few-mode fibers typically have DGDs in the order of a few picoseconds per meter, implying a CF of the order of 10³.

Perturbations to the local optical path of the fiber (e.g., induced by strain or temperature) can be measured by observing changes to the resulting local interference from light coupling, similar to Rayleigh scattering based systems [10], [36]. As light couples from the OAM₀ mode to any of the higher order OAM_{±1} modes, it interferes with pre-existing light in the higher order mode with which it overlaps. The optical path difference accumulated due to propagation as different modes over any length of fiber enables perception of the fiber as a stack of effective interferometers (sensing points), which can be individually accessed by a time-of-flight measurement to determine the position where coupling happened. The resulting noise-like output of the higher order mode (the optical trace), stores the response of each of the sensing points of the fiber at different time instants.

Example recovery methods for the measurand information include observing the changes to the instantaneous phase evolution along the obtained higher order mode output (analogous to coherent phase-sensitive OTDR interrogation [45]), or probing the equivalent frequency shift that compensates the change in the intermodal interference due to a perturbation induced change in local optical path difference (in analogy to frequency-demodulation phase-sensitive OTDR methods [46], [47]).

The latter approach avoids problems resulting from cumulative measurements of phase, such as poor phase estimation at points of fading and ambiguity due to phase unwrapping errors and is further discussed in the second example.

### Second Example: Recovery Using Frequency Sweep [54]

a. Introduction

Consider the interference happening at position z in the fiber, as newly coupled light interferes after travelling a short length dz (stored at a specific time-instant of the recovered optical trace, given by equation 1). The phase difference accumulated between the two interfering waves due to the difference in propagation constants will be Δφ(z)=Δβdz (for Δβ=β₀⁽⁰⁾−β₀^{(±1)}), which may be re-written as

$$Δφ ( z ) = \frac{2 π}{{c}_{0}} ( Δ n ( z ) \cdot dz ) {v}_{0} \qquad ( 2 )$$

Equation 2 illustrates the equivalence of altering the optical path difference (Δn(z)·dz)(Δn=n⁽⁰⁾−n⁽¹⁾, [symbol] being the effective index of each respective mode of [symbol] topological charge) and detuning the probe center frequency v₀ by a specific amount. A change in the optical path difference Δ(Δn(z)·dz) can therefore be adequately compensated by a change in center frequency, such that

$$\frac{Δ {v}_{0}}{{v}_{0}} = \frac{Δ ( Δ n ( z ) \cdot dz )}{( Δ n ( z ) \cdot dz )} . \qquad ( 3 )$$

A strategy for interrogation of all sensing points comprises probing the fiber under test (FUT) with multiple center frequencies and reconstructing the frequency response of each effective interferometer formed at every position in the fiber. A perceived shift in the frequency response is proportional to the optical path difference, according to the relation given in equation 3. Strain and temperature can then be inferred from well known fiber coefficients that take into account the total length change, elasto-optic effect, thermal expansion and thermo-optic effect [47].

In this example, a continuous-wave frequency swept input is used instead of a pulse for interrogation. This type of interrogation is commonly seen in other distributed sensing schemes [36], and generally enables much improved spatial resolutions compared to time-domain (pulsed) implementations. High resolution swept-wavelength interferometry (SWI) [43] techniques in backscattering methods are known to struggle in probing long lengths of fiber due to the limited coherence length of available sources [48]. However, this trade-off is massively relaxed in our design having the local oscillator (OAM₀ output) and measurement path OAM_{±1} output) travel through the same fiber, being therefore automatically optical path-length-matched.

The use of a frequency-domain interrogation method has two main advantages: first, it facilitates the use of the ballistic OAM₀ output as the local oscillator, since the self-heterodyne and time-to-frequency mapping nature of the measurement enables the local oscillator to be conveniently spectrally separated (upconverted in the frequency domain) from the measurement outputs by the simple introduction of a fiber delay; and second, the improved spatial resolution achievable from SWI facilitates the demonstration of proof-of-principle in a benchtop experiment, using shorter perturbation lengths. This is particularly relevant considering the intrinsic penalty to spatial resolution by our proposed technique versus backscattering methods.

The maximum achievable spatial resolution by the method (ζₘₐₓ) of this example is proportional to the total bandwidth spanned by the sweep and the DGD,

$${ζ}_{max} ∝ \frac{1}{{B}_{max} \cdot DGD} .$$

In this example, however, each acquired time-series is divided into several sub-series, each corresponding to the output of a sub-sweep of bandwidth B_{sub}<Bₘₐₓ and a slightly different laser center frequency v₀. This enables the reconstruction the frequency response of the fiber from a single swept acquisition, by simultaneously probing the fiber with multiple center frequencies at the cost of spatial resolution.

The resulting spatial resolution is therefore calculated by

$$ζ = \frac{1}{{B}_{s u b} \cdot DGD}$$

and can be determined in post-processing by choosing the total bandwidth (or time) of each sub-sweep that the acquired portion of the scan is sliced into. This interrogation method also leads to an inverse proportionality between measurand resolution, spatial resolution and total bandwidth Bₘₐₓ, due to the limits of estimation accuracy of the frequency detuning [49].

b. Experimental Details

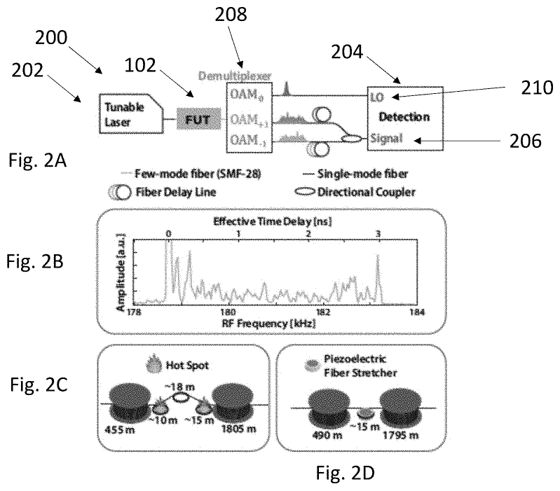

For the data presented herein, a 2300 meter long step-index SMF-28 fiber (carrying 2 mode groups at 1064 nm) was measured. FIG. 2 shows the FUT configurations used in each experiment. The FUT consisted of 2.3 km of SMF-28 fiber carrying three modes over the measurement wavelength range (2 nondegenerate mode groups, OAM₀ and OAM_{±1}), with DGD measured to be 1.23 ps/m. The differential mode group delay (DGD) of the fiber is inferred through previous knowledge of the length of fiber and by deliberately coupling a combination of OAM_{±1} and OAM₀ light at the input, and observing the total delay between the high power peaks resulting from ballistic light at the output.

At the fiber input, only the OAM₀ mode is excited. At the output, the three spatial modes are separated in a free-space section by collimating the fiber output and splitting it into 3 paths. One of the paths is immediately coupled into a single mode HI1060 fiber, without undergoing any mode conversion, while the other two are sent through spiral phase masks (which add/subtract 1 topological charge) before being coupled to a single-mode HI1060 fiber. The spiral phase masks function as spatial mode converters, while the single-mode fibers act as spatial rejection filters that only accept the portion of light with 0 topological charge. The OAM₀ output is then used as the local oscillator of a polarization diversity balanced detection scheme. Each of the OAM_{±1}/OAM₋₁ outputs is delayed by approximately 10/20 meters of fiber (respectively), and then combined through a 50:50 fiber directional coupler. The addition of this delay upconverts each optical trace beatnote resulting from the heterodyne measurement, enabling both optical traces to be recovered in a single measurement [39], [40].

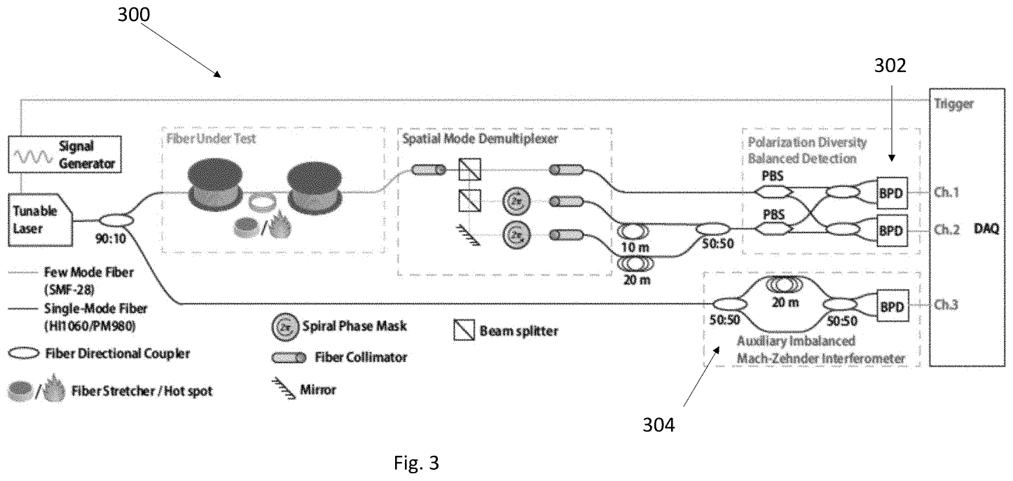

In order to achieve time-to-frequency mapping with a highly nonlinear frequency sweep, we calibrate the sweep rate of the laser using the auxiliary Mach-Zehnder interferometer (see FIG. 3). This allows correction of the effects of nonlinearity by resampling the recovered time series with the instantaneous phase of the auxiliary interferometer signal sₐᵤₓ, obtained by

φᵢₙₛₜ(t)= [symbol] [symbol] {sₐᵤₓ(t)}

where [symbol] is the Hilbert transform. The OAM_{±1}/OAM₋₁ output time-series are then resampled with φᵢₙₛₜ(t−τ_{FUT}), where τ_{FUT} is the total delay accumulated by propagation through the FUT and fibers on the detection setup.

After correction of sweep nonlinearity, the frequency responses of all sensing channels in the fiber can be acquired in a single shot by partitioning each acquired time-series (of length t_{acq}) into Nₛ sub-sections of length t_{sub}<t_{acq}. Each of these sub-sections yields a different optical trace, equivalent to probing the fiber with a sweep of different center frequency and covering a narrower bandwidth (B_{sub}≈ [symbol] γ(t) [symbol] ×t_{sub}, for an average laser sweep-rate [symbol] γ(t) [symbol] ).

All optical traces obtained/computed in this way (from Fourier transforming each sub-sweep) are then interpolated to a predetermined number of samples corresponding to the number of sensing channels we wish to record, therefore correcting any fluctuation of the optical trace width due to the laser sweep rate differences between sub-sections or acquisitions.

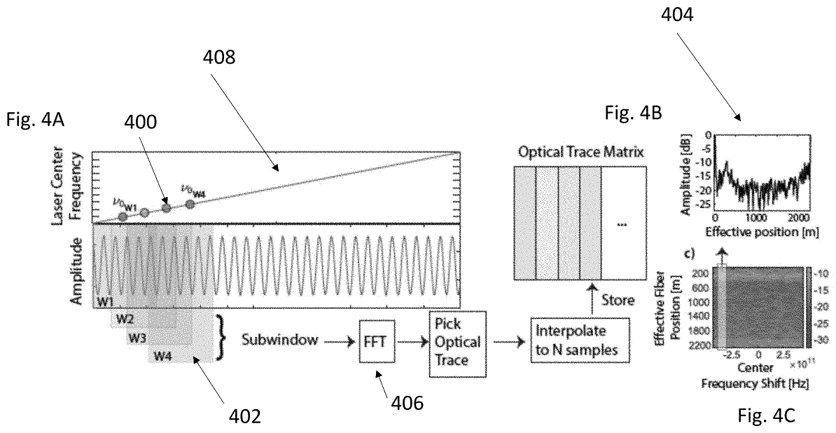

FIG. 4 shows how, by combining the optical traces acquired by successive subsweeps of different center frequencies, the frequency response of all sensing points can be reconstructed.

The interpolated optical traces obtained from all sub-sweeps are then stored as the columns of a matrix: each row stores the frequency response for each individual sensing channel (sensing position), as long as the Nyquist sampling criterion is satisfied

$$δ v < \frac{{B}_{s u b}}{2}$$

where δv is the center frequency difference between each successive sub-sweep, and can be estimated by δv≈ [symbol] γ(t) [symbol] ×Δt_{sub}, Δt_{sub} being the time interval between adjacent subsections of the acquired time-series.

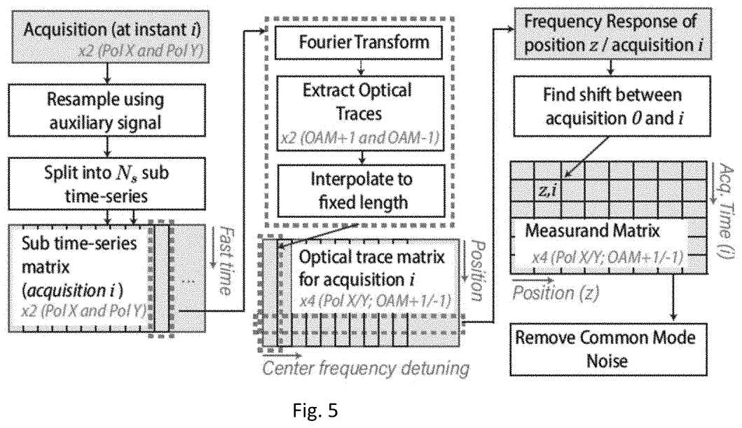

This processing is repeated for all of the four FUT outputs (each pair of output modes and polarizations). Each of these frequency response matrices are independently processed to produce an estimation of the measurand, and then combined by averaging. The full processing stack can be visualized in FIG. 5.

Estimation of measurand amplitude is accomplished by observing the detuning of the frequency responses of each sensing channel. The frequency detuning estimation between the m-th and r-th (reference) acquisitions is accomplished through the generalized cross-correlation algorithm

Δvₘ^{eff}(zᵢ)=arg max{R_{m,r}^{(z}^{ᵢ₎}(Δv)}

where Δvₘ^{eff}(zᵢ) is the effective frequency detuning, proportional to the applied local perturbation to the fiber, and R_{m,r}^{(z}^{ᵢ₎}(Δv) is the cross-correlation between the frequency responses acquired at the instant m and r, for the zᵢ-th measurement point. Subsample accuracy is achieved through parabolic fitting using the three points surrounding the maximum of the cross-correlation.

After recovering the full measurand profile, drifts or fluctuations of the center frequency of the laser are corrected by removing the mean strain/temperature obtained along an unperturbed section of fiber, since they manifest as a spatially correlated common-mode noise component (from meter 700 to 1600 in our experiments) [51].

Although frequency sweep was used as an example frequency interrogation method, other frequency interrogation methods can be used and include (but are not limited to) using external modulators to generate chirped pulses, instead of broadly tunable sources. This removes the need for auxiliary interferometers in the setup. In another example, multi-shot interrogation, instead of single-shot interrogation, can be used to generate different center frequencies.

### Third Example: Multipoint Temperature Measurements [54]

A multipoint sensing measurement was performed by heating two positions in the fiber, generating two hotspots by coiling two sections of fiber (˜10 m long and −15 m long) separated by more than one spatial resolution (FIG. 2). Room temperature was measured to be approximately 22° C.

Each of the fiber coils were heated by hovering a warm object (˜35° C.) close to the coils for about 1 minute without touching the fiber (in order to prevent any strain-induced perturbation), and then removing it and allowing that hot spot to cool down. The spatial resolution was calculated to be 16.1 m according to equation 4.

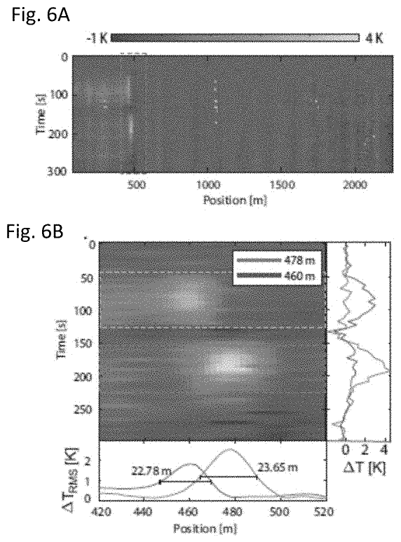

FIGS. 6A-6B illustrate the results. The spatial separation between both perturbations is clearly evidenced by computing the RMS temperature shift in the dashed areas, and plotting them in the bottom part of the figure. The spatial full-width at half maximum for each perturbation is observed to be 22.78 m for the ˜10 m long hot spot and 23.65 for the ˜15 m long one. These results are reasonably consistent with the estimated lengths for the coils and the calculated spatial resolutions, although they seem to suggest some worsening of spatial resolution, which is expected to occur due to fluctuations in the laser sweep rate over each acquisition.

The temperature is calculated from the apparent effective frequency shift using standard coefficients used for telecommunication step-index fibers [47]

$$Δ T \approx - \frac{1}{6.92 \times 1 {0}^{- 6}} \frac{Δ {v}_{0}}{{v}_{0}} .$$

The appearance of some residual crosstalk between spatial channels at positions prior to the measurement can be observed. While crosstalk effects have been observed for other Rayleigh based distributed sensing methods, there are clear distinctions when compared to our approach in this example. First, spatial crosstalk normally affects subsequent positions in backscattering-based technologies, and can be calculated from the amplitude of the perturbation that induces it [50]. This is contrasted with what is observed in the transmission setup: the crosstalk affects positions prior to the point of perturbation, and does not seem to scale predictably with the perturbation that induces it. This suggests that the origin might be an indirect effect, onset by changes to the strong coupling between the two degenerate OAM_{±1} modes. One possible explanation in this case may be a change in coupling strength from a combination of the fiber coiling and thermal effects. This is supported by the fact that the shorter coil had approximately half of the coiling radius as the longer coil (leading to stronger crosstalk). This may not occur in fiber installations that are not substantially bent or coiled, and may be avoided altogether through the use of a nondegenerate higher order mode for interrogation (thus avoiding any strong coupling effects), in fibers carrying a higher number of modes.

### Fourth Example: Strain Measurements [54]

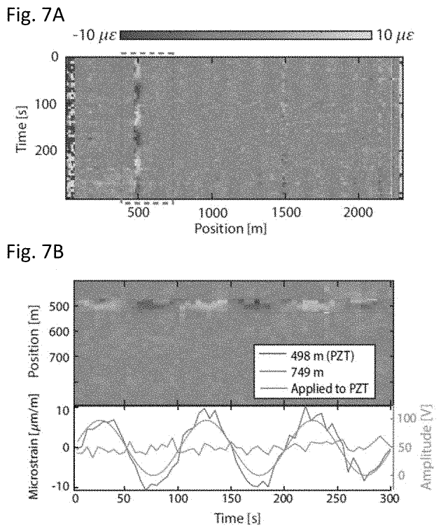

To measure strain, a roughly 15 m long section of the fiber was coiled around a piezoelectric cylinder, at meter 500 (FIG. 2). A slow sinusoidal oscillation with 100 s period was applied to the fiber stretcher, with 100 V amplitude (100nε/V, according to specifications). The strain distribution was recovered over 300 seconds, and is represented in FIG. 7. The acquired effective frequency shift was converted to strain through the following relation [47]

$$ε \approx - \frac{1}{0 \text{.78}} \frac{Δ {v}_{0}}{{v}_{0}}$$

The spatial resolution was selected to be 16.1 m, which was found to maximize the strain SNR for the recovered perturbation. The amplitude of the measured strain sine wave was found to be 16.4 με, and the strain resolution (computed as the average of the standard deviations of all points in an undisturbed section of fiber, from meter 700 to 1600) was measured as 1.4με.

### Fifth Example: Incoherent Measurements of Coupling Strength

The shaded region in FIG. 1C illustrates a hypothetical output from a higher order mode of a fiber, resulting from an input to a fundamental mode and a perfectly constant coupling strength along the fiber length. The output comprises a pedestal shaped broad pulse. However, because the light is coherent, constructive and/or destructive interference with light coupled into the higher mode at different positions leads to observation of structure in the response.

In the interferometric mode of operation discussed in examples 1-4, changes in these interference features can be used to measure changes in fiber strain or temperature. In order to measure coupling strength (due to fiber bends, for example), the features in the signal from interference effects are considered noise and need to be removed to obtain the response for constant coupling.

One method for removing the interference component is to probe the fiber many times with pulses (or equivalently frequency sweeps) of slightly different frequencies and recording the outputs. Averaging the responses (and “noisy” interference effects) retains only the envelope related to the coupling strength.′

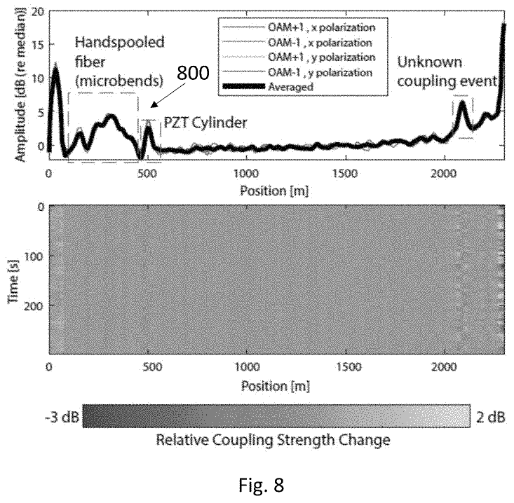

FIG. 8 illustrates an example of an incoherent acquisition (done for the same dataset as the one for the strain measurements in the fourth example). Despite baseline changes in coupling strength from spooling, we see no relevant changes of coupling strength as a result of the perturbation at the position of the PZT (the bending radius is not expected to change meaningfully, and axial strains should not induce intergroup mode coupling [11]). This proves that the observations in the first, second, third, and fourth examples are result indeed from changes to the local interference, and not from changes to coupling strength [12].

Notably, since both methodologies (coherent interrogation for optical path measurements, and incoherent interrogation for coupling strength measurements) differ only in the post-processing, they can be implemented simultaneously.

### Sixth Example: Measuring Spectral Phase

A first method for measuring the spectral phase of the output from the fiber comprises the following steps.
a.- Recording the output from the fiber in response to an input comprising a sweep of frequencies.
b. Performing a Fourier Transform of the output to obtain the Fourier components.
c.-measuring the angle of each Fourier component (instead of the absolute value) as the spectral phase.
d. observing changes in the local “slope” of the angle of Fourier transform over multiple acquisitions (sweeps), to measure changes in, or quantify, the physical parameter(s).

Because measurement of the spectral phase is itself cumulative, the phases differences are measured over “slow time” (between different acquisitions), as compared to the“fast-time” frame changes in the phase resulting from the interference of light coupling at different locations along the fiber. Although both slow time measurements and fast time measurements should yield similar results, discrepancies arise due to real world fluctuations in sweep rate and center frequency of the laser sweep. These fluctuations introduce noise during unwrapping operations used to account for phase being defined from 0 to 2 pi. In some examples, phase different measurements over fast time and slow time can be used in tandem for redundancy.

A second method comprises using pulse interrogation (instead of frequency sweep interrogation). The steps comprise:
a. Recording the output from the fiber in response to the pulse, optionally using a dedicated path for the local oscillator.
b. Measuring the instantaneous phase of the output, e.g., using a dual-comb approach, to obtain a time-expanded version of the signal.
c. Performing a Hilbert transform on the time expanded signal.
d. measuring the angle of each component of the Hilbert transform as the spectral phase.
e. observing changes in the local “slope” of the angle over multiple acquisitions (sweeps), to measure changes in, or quantify the physical parameter(s).

Example Processes, Systems and Methods

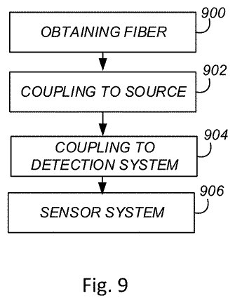

FIG. 9 s a flowchart illustrating a method of making a sensor system.

Block 900 represents obtaining an optical fiber comprising a first spatial channel and a second spatial channel, wherein the spatial channels are coupled and electromagnetic radiation propagates with different group velocities in each of the spatial channels. The optical fiber may transmit the electromagnetic radiation at telecom wavelengths (e.g., 1-10 microns wavelength), or any wavelength in range of 400 nm-10 microns, for example, and support data transmission using a variety of multiplexing schemes.

Block 902 represents coupling a source (e.g., a laser) inputting the electromagnetic radiation into the first (e.g., fundamental) spatial channel at an input. In one or more examples, the source may be configured to output the electromagnetic radiation capable of performing frequency interrogation of the fiber (e.g., frequency sweep, chirped pulses, or one or more shot interrogation) or spectral phase interrogation of the fiber. The source may include modulators and/or controllers with appropriate functionality for performing the interrogation.

Illustrative embodiments described herein use frequency sweeps, because it is generally easier to get higher spatial resolutions. However, pulses can also be used and, without being bound by a particular scientific theory, and in one or more examples, may be considered equivalent: if we have a delayed version of the swept light as the local oscillator, then we get the same information we would by probing with a pulse (of the same center frequency as the sweep) by doing a Fourier transform.

Block 904 represents coupling a detection system to the output of the fiber. The detection system may comprise a detector detecting the transmitted electromagnetic radiation and generating a signal in response thereto, and a computer configured to process the signal to obtain a localized measurement of one or more physical parameters. The detection system detects the transmission from the input to the output, e.g., comprising the light that propagated along the fiber, without being reflected backwards.

Block 906 represents the end result, a sensor system.

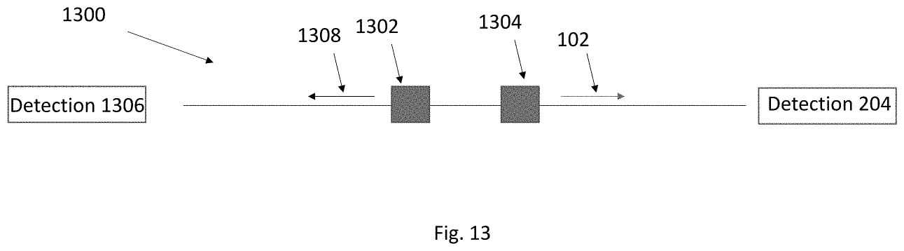

Illustrative embodiments of the sensor system include, but are not limited to, the following examples (referring also to FIGS. 1-13).
1. A sensor system 100, 200, 300 comprising:
an optical fiber 102 comprising a first spatial channel 104 and at least one second spatial channel 106, wherein the spatial channels are coupled (with a coupling strength) and electromagnetic radiation 108 propagates with different group velocities in each of the spatial channels;
a source 110 inputting the electromagnetic radiation 108 into the first spatial channel at an input 112; and
a detection system 204 coupled to an output 114 (e.g., distal end) of the fiber, the detection system comprising:
   a detector 302 detecting a transmission 120 of the electromagnetic radiation, from the input to the output, and coupled into the second spatial channel at different positions 116 along the fiber, and generating one or more signals 206 in response thereto; and
   a computer 1100 processing the signal to obtain one or more localized measurements of one or more physical parameters of the fiber 102 at one or more of the different positions 116 along the fiber 102.
2. The system of example 1, wherein the spatial channels 104, 106 are weakly coupled, e.g., such that the “dispersion” or broadening a pulse of the electromagnetic radiation experiences is proportional to the length of fiber, and not to its square root, so that ballistic light (in the first spatial channel, e.g., comprising a fundamental mode, that did not couple to the second spatial channel, e.g., higher mode) to has an energy at least one order of magnitude higher than all the energy in the higher-order-mode(s).
3. The sensor system of example 1 or 2, wherein the localized measurement comprises a quantitative measurement, the fiber comprises a step-index fiber, a graded-index few-mode fiber, a heterogeneous multicore fiber, or a coupled-core multicore fiber, and the spatial channels comprise co-propagating modes or cores having the different group velocities for the electromagnetic radiation.
4. The sensor system of any of the examples 1-3, comprising a plurality of the fibers distributed in a network, wherein the spatial channels comprise spatial and wavelength multiplexed data channels.
5. The sensor system of any of the examples 1-4, wherein the physical parameters comprise at least one of strain, temperature, birefringence, or refractive index of the fiber 102.
6. The sensor system of any of the examples 1-5, further comprising a polarization synthesizer, wherein the source inputs the electromagnetic radiation via the polarization synthesizer and the physical parameter comprises at least one of a circular component or a linear component of birefringence.
7. The sensor system of any of the examples 1-6, wherein the fiber is coupled to one or more in line amplifiers 1302 amplifying the electromagnetic radiation at one or more of different positions along a length of the fiber, so that the detection system measures the interference with increased signal to noise.
8. A telecommunications link 1300 comprising the sensor system of any of the examples 1-7, comprising the fiber coupled to one or more non-reciprocal elements 1304 (e.g., isolator or circulator), wherein the non-reciprocal elements prevent backward propagation of the electromagnetic radiation in the fiber.
9. The sensor system 100 of any of the examples 1-7, wherein the computer: processes (e.g., averages) the signal (e.g. to remove coherent interference contributions 118) so as to identify changes 800 in a coupling strength of the coupling between the coupled spatial channels 104 as a function of the different positions 116, and processes the changes 800 in the coupling strength to obtain the one or more localized measurements of the one or more physical parameters comprising at least one of transverse stress, a bending, or transverse pressure applied to the fiber 102.
10. The sensor system of any of the examples 1-9, wherein:
the fiber 102 transmits the electromagnetic radiation 108 modulated according to a space-division multiplexing scheme, and
the computer:
   processes the signal 206 so as to identify changes 800 in the coupling strength of the coupling between the spatial channels 104 as a function of the different positions 116, and
   processes the changes 800 in the coupling strength to obtain the one or more localized measurements of the one or more physical parameters.
11. The sensor system of example 10, wherein the spatial channels 104 comprise at least two co-propagating modes or supermodes, with different group velocities, in the fiber 102 configured for space-division multiplexing ready fibers, and
the computer process the signal 206 to identify and/or characterize local and/or relative changes 800 in a coupling strength of the electromagnetic radiation 108 between the modes at one or more of the different positions 116, to determine the localized measurements comprising quantitative measurements of multiple physical parameters.
12. The sensor system of any of the examples 1-11, wherein the computer 1100 processes the signal 206 to perform distributed characterization of relative local coupling strength along the fiber 102.
13. The sensor system of any of the examples 1-12, wherein the computer:
processes the signal by:
sampling at a sampling rate to obtain sampled data, and
identifying interference 118 or changes 800 in the coupling strength in the sampled data, the interference 118 resulting from the electromagnetic radiation coupled into the second spatial channel 106 at different positions 116 along the fiber; and
wherein the sampling rate is selected independently of the round-trip time for propagation of the electromagnetic radiation 108 between the input 112 and the output 114.
14. The sensor system of any of the examples 1-8 or 13, wherein the computer processes the signal 206 to identify interference 118 of the electromagnetic radiation 108 resulting from the electromagnetic radiation 108 coupled into the second spatial channel 106 at different positions 116 along the fiber 102; and the computer processes the interference 118 to obtain the one or more localized measurements of the one or more physical parameters at one or more of the different positions 116 along the fiber.
15. The sensor system of any of the examples 1-8, 13, or 14 wherein:
the source 202 outputs the electromagnetic radiation 108 comprising multiple center frequencies 400, and
the computer 1100 identifies the interference 118 at each of the one or more different positions by:
   splitting or partitioning the signal into a plurality of sections or subbands 402, each of the sections or subbands comprising a frequency response 404 of the fiber 102 to a different one of the center frequencies 400, and
   associating each of the frequency responses 404 to a different one of the positions 116 along a length the fiber; and
the computer 1100 obtains the localized measurement(s) by comparing each of one or more of the frequency responses 404 to a previously acquired reference.
16. The sensor system of any of the examples 1-8, or 13-15 wherein:
the source 202 outputs the electromagnetic radiation 108 comprising multiple center frequencies 400, and
wherein the computer processes the signal 206 by:
splitting the full sweep signal into a plurality sub-bands 402,
performing a Fourier Transform 406 of each of the subbands 402,
constructing the frequency response 404 at each of the positions in the fiber, using the absolute value of the Fourier transforms; and
quantifying changes in the frequency response using cross correlation.
17. The sensor system of example 15, wherein the comparing obtains a frequency detuning with respect to the reference and the computer 1100 calculates the localized measurement from the frequency detuning.
18. The sensor system of example 16 or 17, further comprising an auxiliary interferometer 304 coupled to the source, wherein:
the source 202 inputs the electromagnetic radiation 108 comprising a linear frequency sweep 408 comprising the center frequencies 400 to the auxiliary interferometer 304 and the fiber 102;
the auxiliary interferometer 304 outputs an auxiliary signal and the computer 1100 uses the auxiliary signal to determine a nonlinearity of the frequency sweep; and
the computer adjusts the frequency responses 404 to account for the nonlinearity.
19. The sensor system of any of the examples 14-18, wherein the source 202 outputs chirped pulses comprising the plurality of center frequencies or a plurality of shots of the electromagnetic radiation 108 each comprising a different one of the center frequencies.
20. The sensor system of any of the examples 1-19, wherein the computer:
processes the signal so as to identify changes in the spectral phase of the signal 206, and/or one or more phase differences in the signal resulting from interference 118 between the electromagnetic radiation 108 coupled into the second spatial channel 106 at the different positions of strong coupling between the spatial channels 104, 106, and
processes the phase differences or spectral phase changes to obtain the localized measurements (e.g., comprising quasi distributed measurements of the physical parameters).
21. The sensor system of any of the examples 1-20, wherein:
the source 202 outputs the electromagnetic radiation 108 comprising multiple center frequencies, and
wherein the computer processes the signal 206 by:
performing a Fourier Transform of the signal 206;
measuring the angle of each Fourier component as the spectral phase;
measuring changes in the local “slope” of the angle of Fourier transform over multiple acquisitions to determine the physical parameters.
21. The sensor system of any of the examples 1-21, wherein the physical parameters comprise inter-mode coupling at the different positions 116 of components coupled to the fiber 102, the different components comprising at least one of an amplification stage, a splice, a connector, a multiplexer, or a demultiplexer 208.
22. The sensor system of any of the examples 1-21, wherein:
the detector comprises balanced detectors 302 detecting a local oscillator 210 comprising the electromagnetic radiation 108 outputted from the first spatial channel 104, and the electromagnetic radiation outputted from the second spatial channel 106, wherein the local oscillator and the electromagnetic radiation in the second spatial channel are automatically path length matched by virtue of being carried in the same fiber 102 and common mode noise is rejected using the local oscillator.
23. The sensor system of any of the examples 1-22, further comprising a second detection system 1306 measuring backwards propagation 1308 of the electromagnetic radiation 108 resulting from reflection or backscattering events of the electromagnetic radiation towards the input 112, wherein the computer 1100 determines the physical parameters with denser spatial sampling in-between the reflection or backscattering events.
24. The sensor system of any of the examples 1-23, further comprising a second detection system 1306 measuring backwards propagation 1308 of the electromagnetic radiation 108 resulting from reflection or backscattering events towards the input 112, wherein the computer 1100 uses a simultaneous measurement of the backwards propagation 1308 by the second detection system 1306 and the forward transmission 120 to isolate a contribution of the physical parameter comprising a circular component of the birefringence vector.
25. The sensor system of example 23 or 24, wherein sensor system 100 comprises a hybrid system 1300 and the reflection events can be retrieved from diagnosis channels (using Bragg reflectors and high-loss-loopback paths) in the fiber 102 comprising a long-haul, amplified fiber.
26. The sensor system of any of the examples 1-25, wherein the computer 1100 compares changes in the interference 118 and the coupling strength 800 between the spatial channels 104, 106 comprising multiple higher order copropagating modes of the electromagnetic radiation 108, so as to obtain the local measurements of a plurality of the physical parameters, resulting from a perturbation of the fiber, with reduced cross-sensitivity between parameters.
27. The sensor system of example 26, wherein the fiber 102 comprises multiple modes having different responses of the physical parameter (e.g., different refractive index or different thermo-optic effect) enabling discrimination between different perturbations affecting the local optical path of the fiber 102, wherein the detector outputs a signal 206 in response to the transmitted 120 electromagnetic radiation outputted from each mode and the computer processes each of the signals 206.
28. The sensor system of any of the examples 1-27 comprising a plurality of the spatial channels 104, 106, and a plurality of the signals 206 generated from the transmitted electromagnetic radiation outputted from the spatial channels, so as to obtain localized measurements of a plurality of the physical parameters.
29. The sensor system of example 28, wherein each of the physical parameters is measured from a different one of the signals generated from detecting the transmitted electromagnetic radiation outputted from a different one of the spatial channels (i.e., the i^{th} physical parameter is measured by processing the i^{th} signal generated from the transmitted electromagnetic radiation outputted from the i^{th} spatial mode, for n channels and physical parameters 1<i≤n).
30. The sensor system of any of the examples 1-14, 18-19, or 21-29, wherein the processing comprises receiving the signal 206 comprising stored data from the transmitted electromagnetic radiation comprising a full frequency sweep 408, dividing the stored data into a plurality of many time sections (i.e., sub-sweeps 402), wherein the greater the number of divisions, the worse the spatial resolution, and performing a Fourier Transform of each of the sub-sweeps or time sections, to obtain one or more impulse responses of the fiber, wherein each of the sub-sweeps gives the impulse response equivalent to probing the fiber with a pulse centered at the center frequency 400 of that sweep (so by dividing into many sub-sweeps we are effectively probing the fiber with what would be obtained by probing at the center frequency).
31. The sensor system of example 30, further comprising performing an incoherent/coupling strength measurement, wherein the processing further comprises averaging all the impulse responses obtained from each subsweep/time-section 402, e.g., so as to obtain one or more coupling strength measurements at the one or more different positions 116 of the fiber 102.
32. The sensor system of example 30 or 31, further comprising performing coherent/interferometric measurements, wherein the processing further comprises: for each point/position in the impulse response obtained from probing at the different frequencies, constructing the frequency response 404 of that point/position in the fiber (i.e., the “effective sensor”); and performing a cross-correlation of one or more of the frequency responses 404 with a previously acquired one, so as to determine how shifted the frequency response is (e.g., compute the maximum index of the cross-correlation).
33. The sensor system of example 31 or 32, further comprising determining the localized measurement(s) of the one or more physical parameter(s) from the coupling strength measurement(s) and/or cross-correlation(s).
34. The sensor system of any of the examples 1-33, wherein the signal comprises a plurality of signals (e.g., e.g., one from each of a plurality of the spatial channels, or from different acquisitions), the localized measurement comprises a plurality of measurements, and the physical parameter comprises a plurality of physical parameters.
35. The sensory system of any of the examples 1-34, wherein the fiber is located in a building, underground, on/in the ground, or on/in an ocean floor.
36. A system comprising a mode-walk-off interferometer coupled to or comprising a fiber, or a method comprising performing mode-walk interferometry of a fiber, configured to measure and localize physical changes to a fiber.
37. The system or method of any of the examples comprising a plurality of the fibers.
38. A geophysical sensing instrument, or seismographic instrument, smart building, structural health monitoring system, mechanical system health monitoring system, aircraft, or telecom system comprising the sensor system of any of the examples 1-38.
39. A computer implemented system 1100, comprising: one or more processors; one or more non-transitory memories; and one or more programs stored in the one or more non-transitory memories, wherein the one or more programs executed by the one or more processors process the signal to obtain one or more localized measurements of one or more physical parameters of the fiber 102 at one or more of the different positions along the fiber 102.
40. The computer implemented system of example 39, wherein the computer of any of the examples 1-38 comprises the computer of any of the examples 1-38 comprises the computer implemented system 1100.
41. The system of example 36 comprising the sensory system of any of the examples 1-35 or 36-41.
42. The system of any of the examples 1-41, wherein processing of the signal by the computer includes, but is not limited to, one r more of averaging, applying functions/transforms to, Fourier Transforming, splitting, signal processing, manipulating, etc.
43. The system of any of the examples 1-42, wherein the detection system comprises, consists of, consists essentially of, or is one or more detectors. Example detectors include, but are not limited to photodiodes or photodetectors (e.g., semiconductor photodetectors or photodiodes), or balanced photodetectors or photodiodes. The detection system may further comprise one or more circuits or computers for processing charge or detection signals generated in response to the electromagnetic radiation.
44. The system of any of the examples 1-43, wherein the computer comprises, consists of, or consists essentially of one or more circuits.
45. The system of any of the examples 1-44, wherein the source is a source the electromagnetic radiation comprising coherent electromagnetic radiation including, but not limited to, a laser, or an array or optical modulator (spatial light modulator, digital micromirror device) emitting coherent electromagnetic radiation.

Although the sensor system examples 1-45 mention measurement of physical parameters, the sensor system of any of the examples 1-45 can also be used to obtain localized measurements of properties of the fiber or environment of the fiber generally, including one or more chemical parameters or properties, or biological properties or parameters.

Method of Operation

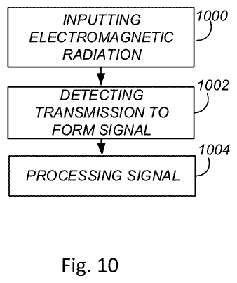

FIG. 10 illustrates a method of sensing comprising the following steps.

Block 1000 represents inputting electromagnetic radiation into a first spatial channel of an optical fiber comprising the first spatial channel and a second spatial channel, wherein the spatial channels are coupled and electromagnetic radiation propagates with different group velocities in each of the spatial channels. In various examples, the spatial channels comprise modes or supermodes of the fiber.

Block 1002 represents detecting a transmission of the electromagnetic radiation coupled into the second spatial channel at different positions along the fiber between the input to the output, and generating a signal in response thereto.

Block 1004 represents processing the signal to obtain one or more localized measurements of one or more physical parameters at one or more of the different positions along the fiber. Example processing includes, but is not limited to, one r more of averaging, applying functions/transforms to, Fourier Transforming, splitting, signal processing, manipulating, etc.

In one example, the method of sensing comprises:
inputting electromagnetic radiation into a first spatial channel of an optical fiber comprising the first spatial channel and a second spatial channel, wherein the spatial channels are weakly coupled and electromagnetic radiation propagates with different group velocities in each of the spatial channels;
detecting a transmission, from the input to the output, of the electromagnetic radiation coupled into the second spatial channel at different positions along the fiber between the input to the output, and generating a signal in response thereto; and
processing the signal to obtain a localized measurement of a physical parameter at one or more of the different positions along the fiber.

In another example, a computer implemented method of sensing comprises receiving a signal, processing the signal to obtain a localized measurement of a physical parameter at one or more of the different positions along the fiber; and outputting the physical parameter, e.g., for use in an application (e.g., geophysical, structural health monitoring, structural, or seismological application, smart building application). The signal(s) can be obtained by inputting electromagnetic radiation into a first spatial channel of an optical fiber comprising the first spatial channel and a second spatial channel, wherein the spatial channels are weakly coupled and electromagnetic radiation propagates with different group velocities in each of the spatial channels; and detecting a transmission, from the input to the output, of the electromagnetic radiation coupled into the second spatial channel at different positions along the fiber between the input to the output, and generating the signal(s) in response thereto; wherein the signal(s) are sent to the computer for processing.

The method can be implemented using the sensor system of any of the examples 1-45.

Hardware Environment

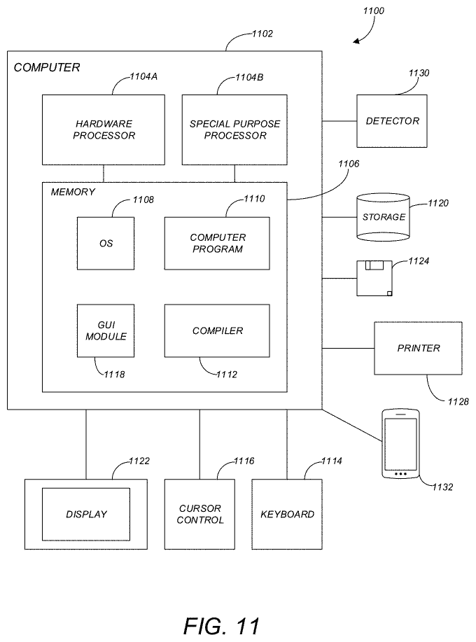

FIG. 11 is an exemplary hardware and software environment 1100 (referred to as a computer-implemented system and/or computer-implemented method) used to implement one or more embodiments of the invention. The hardware and software environment includes a computer 1102 and may include peripherals. Computer 1102 may be a user/client computer, server computer, or may be a database computer. The computer 1102 comprises a hardware processor 1104A and/or a special purpose hardware processor 1104B (hereinafter alternatively collectively referred to as processor 1104) and a memory 1106, such as random access memory (RAM). The computer 1102 may be coupled to, and/or integrated with, other devices, including input/output (I/O) devices such as a keyboard 1114, a cursor control device 1116 (e.g., a mouse, a pointing device, pen and tablet, touch screen, multi-touch device, etc.) and a printer 1128. In one or more embodiments, computer 1102 may be coupled to, or may comprise, a portable or media viewing/listening device 1132 (e.g., cellular device, personal digital assistant, etc.). In yet another embodiment, the computer 1102 may comprise a multi-touch device, mobile phone, gaming system, internet enabled television, television set top box, or other internet enabled device executing on various platforms and operating systems.

In one embodiment, the computer 1102 operates by the hardware processor 1104A performing instructions defined by the computer program 1110 (e.g., a signal processing application) under control of an operating system 1108. The computer program 1110 and/or the operating system 1108 may be stored in the memory 1106 and may interface with the user and/or other devices to accept input and commands and, based on such input and commands and the instructions defined by the computer program 1110 and operating system 1108, to provide output and results.

Output/results may be presented on the display 1122 or provided to another device for presentation or further processing or action. The image may be provided through a graphical user interface (GUI) module 1118. Although the GUI module 1118 is depicted as a separate module, the instructions performing the GUI functions can be resident or distributed in the operating system 1108, the computer program 1110, or implemented with special purpose memory and processors.

In one or more embodiments, the display 1122 is integrated with/into the computer 1102 and comprises a multi-touch device having a touch sensing surface (e.g., track pod or touch screen) with the ability to recognize the presence of two or more points of contact with the surface. Examples of multi-touch devices include mobile devices (e.g., IPHONE, NEXUS S, DROID devices, etc.), tablet computers (e.g., IPAD, HP TOUCHPAD, SURFACE Devices, etc.), touch tables, and walls (e.g., where an image is projected through acrylic and/or glass, and the image is then backlit with LEDs).

Some or all of the operations performed by the computer 1102 according to the computer program 1110 instructions may be implemented in a special purpose processor 1104B. In this embodiment, some or all of the computer program 1110 instructions may be implemented via firmware instructions stored in a read only memory (ROM), a programmable read only memory (PROM) or flash memory within the special purpose processor 1104B or in memory 1106. The special purpose processor 1104B may also be hardwired through circuit design to perform some or all of the operations to implement the present invention. Further, the special purpose processor 1104B may be a hybrid processor, which includes dedicated circuitry for performing a subset of functions, and other circuits for performing more general functions such as responding to computer program 1110 instructions. In one embodiment, the special purpose processor 1104B is an application specific integrated circuit (ASIC).

The computer 1102 may also implement a compiler 1112 that allows an application or computer program 1110 written in a programming language such as C, C++, Assembly, SQL, PYTHON, PROLOG, MATLAB, RUBY, RAILS, HASKELL, or other language to be translated into processor 1104 readable code. Alternatively, the compiler 1112 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 1110 accesses and manipulates data accepted from I/O devices and stored in the memory 1106 of the computer 1102 using the relationships and logic that were generated using the compiler 1112.

The computer 1102 also optionally comprises an external communication device such as a modem, satellite link, Ethernet card, or other device for accepting input from, and providing output to, other computers 1102.

In one embodiment, instructions implementing the operating system 1108, the computer program 1110, and the compiler 1112 are tangibly embodied in a non-transitory computer-readable medium, e.g., data storage device 1120, which could include one or more fixed or removable data storage devices, such as a zip drive, floppy disc drive 1124, hard drive, CD-ROM drive, tape drive, etc. Further, the operating system 1108 and the computer program 1110 are comprised of computer program 1110 instructions which, when accessed, read and executed by the computer 1102, cause the computer 1102 to perform the steps necessary to implement and/or use the present invention or to load the program of instructions into a memory 1106, thus creating a special purpose data structure causing the computer 1102 to operate as a specially programmed computer executing the method steps described herein. Computer program 1110 and/or operating instructions may also be tangibly embodied in memory 1106 and/or data communications devices 1130, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 1102.

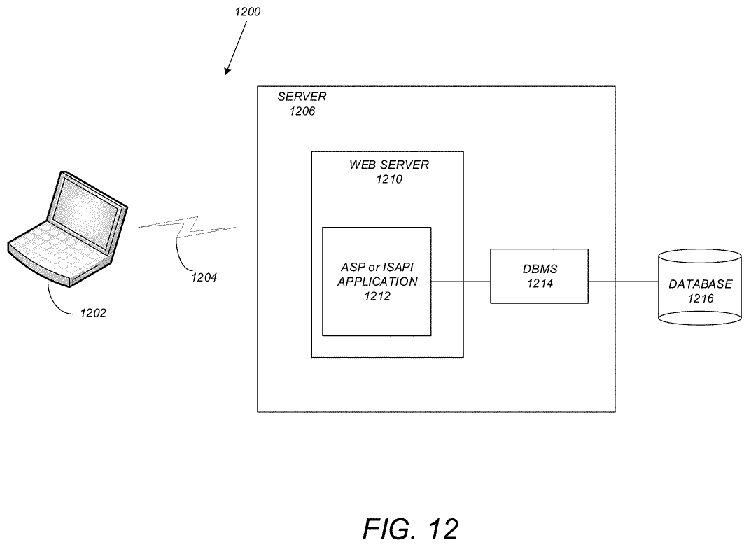

FIG. 12 schematically illustrates a typical distributed/cloud-based computer system 1200 using a network 1204 to connect client computers 1202 to server computers 1206. A typical combination of resources may include a network 1204 comprising the Internet, LANs (local area networks), WANs (wide area networks), SNA (systems network architecture) networks, or the like, clients 1202 that are personal computers or workstations (as set forth in FIG. 11), and servers 1206 that are personal computers, workstations, minicomputers, or mainframes (as set forth in FIG. 11). However, it may be noted that different networks such as a cellular network (e.g., GSM [global system for mobile communications] or otherwise), a satellite based network, or any other type of network may be used to connect clients 1202 and servers 1206 in accordance with embodiments of the invention.

A network 1204 such as the Internet connects clients 1202 to server computers 1206. Network 1204 may utilize ethernet, coaxial cable, wireless communications, radio frequency (RF), etc. to connect and provide the communication between clients 1202 and servers 1206. Further, in a cloud-based computing system, resources (e.g., storage, processors, applications, memory, infrastructure, etc.) in clients 1202 and server computers 1206 may be shared by clients 1202, server computers 1206, and users across one or more networks. Resources may be shared by multiple users and can be dynamically reallocated per demand. In this regard, cloud computing may be referred to as a model for enabling access to a shared pool of configurable computing resources.

Clients 1202 may execute a client application or web browser and communicate with server computers 1206 executing web servers 1210. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 1202 may be downloaded from server computer 1206 to client computers 1202 and installed as a plug-in or ACTIVEX control of a web browser. Accordingly, clients 1202 may utilize ACTIVEX components/component object model (COM) or distributed COM (DCOM) components to provide a user interface on a display of client 1202. The web server 1210 is typically a program such as MICROSOFT'S INTERNET INFORMATION SERVER.

Web server 1210 may host an Active Server Page (ASP) or Internet Server Application Programming Interface (ISAPI) application 1212, which may be executing scripts. The scripts invoke objects that execute business logic (referred to as business objects). The business objects then manipulate data in database 1216 through a database management system (DBMS) 1214. Alternatively, database 1216 may be part of, or connected directly to, client 1202 instead of communicating/obtaining the information from database 1216 across network 1204. When a developer encapsulates the business functionality into objects, the system may be referred to as a component object model (COM) system. Accordingly, the scripts executing on web server 1210 (and/or application 1212) invoke COM objects that implement the business logic. Further, server 1206 may utilize MICROSOFT'S TRANSACTION SERVER (MTS) to access required data stored in database 1216 via an interface such as ADO (Active Data Objects), OLE DB (Object Linking and Embedding DataBase), or ODBC (Open DataBase Connectivity).

Generally, these components 1200-1216 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 1202 and 1206 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 1202 and 1206. Embodiments of the invention are implemented as a software/CAD application on a client 1202 or server computer 1206. Further, as described above, the client 1202 or server computer 1206 may comprise a thin client device or a portable device that has a multi-touch-based display.

Advantages and Improvements

Advantages of a sensor system measuring physical parameters from transmission signals only (not backward propagation) include, but are not limited to:
Ability to implement distributed sensing capable of overcoming non-reciprocal elements in telecommunication links, while retaining the localization information.
Ability to implement in networks benefitting from in-line amplification.
Relaxed limitations on sampling rate, due to not requiring a full fiber roundtrip in between probe pulses or sweeps.
Automatic path-length matching of local oscillator and measurement paths by carrying the local oscillator as one of the propagated modes in the fiber, foregoing the need for a path-length matched fiber.
Ability to produce quantitative, localized measurements of birefringence, assuming a few alterations to the proposed experimental setup, in particular the circular component of the birefringence vector (as well as linear birefringence) which is not measurable in backscattering-based systems. While reflection methods can only measure linear birefringence, a co-propagating approach as described herein can also measure the circular component of birefringence, in addition to the linear component.
Ability to produce localized measurements of bending or transverse pressure (by observing changes of coupling strength), with only a few alterations to the post-processing.

Moreover, the sensor system enables measurement of multiple physical parameters while minimizing cross sensitivity. With typical measurements of changes in optical path using approaches described herein, both a change of the fiber length (e.g., by stretching it), or a change in the refractive index (e.g., by heating it up) might be indistinguishable, hence the cross-sensitivity. However, when utilizing multiple different modes, the refractive index is different, and the thermo-optic effect is potentially different as well, enabling discrimination between stretching or heating, for example, or more generally between different perturbations affecting the local optical path of the fiber.

### REFERENCES

The following references are incorporated by reference herein.
[1] Z. He and Q. Liu, “Optical Fiber Distributed Acoustic Sensors: A Review,” Journal of Lightwave Technology, vol. 39, no. 12, pp. 36713686, 2021
[2] P. Lu, N. Lalam, M. Badar, B. Liu, B. T. Chorpening, M. P. Buric and P. R. Ohodnicki, “Distributed optical fiber sensing: Review and perspective,” Applied Physics Reviews, vol. 6, no. 4, 2019.
[3] G. Bashan, H. H. Diamandi, Y. London, E. Preter, and A. Zadok, “Optomechanical time-domain reflectometry,” Nature Communications, vol. 9, no. 1, p. 2991, 2018.
[4] D. M. Chow, Z. Yang, M. A. Soto, and L. Thevenaz, “Distributed forward Brillouin sensor based on local light phase recovery,” Nature communications, vol. 9, no. 1, pp. 1-9, 2018.
[5] G. Bashan, Y. London, H. Hagai Diamandi, and A. Zadok, “Distributed cladding mode fiber-optic sensor,” Optica, vol. 7, no. 1, p. 85, 2020.
[6] J. Jia, Y. Yang, M. Zuo, J. Cui, Y. Gao, J. Yu, H. Yu, Z. R. Zhang, Z. Chen, Y. He, and J. Li, “Distributed Transverse Stress Sensor Based on Mode Coupling in Weakly-Coupled FMF,” IEEE Photonics Journal, vol. 14, no. 1, pp. 1-1, 2021.
[7] L. Zhang, Z. Yang, L. Szostkiewicz, K. Markiewicz, S. Mikhailov, T. Geernaert, E. Rochat, and L. Thevenaz, “Long-distance distributed pressure sensing based on frequency-scanned phase-sensitive optical time-domain reflectometry,” Optics Express, vol. 29, 062021.
[8] D. Zhou, Y. Dong, B. Wang, C. Pang, D. Ba, H. Zhang, Z. Lu, H. Li, and X. Bao, “Single-shot BOTDA based on an optical chirp chain probe wave for distributed ultrafast measurement,” Light: Science and Applications, vol. 7, no. 1, p. 32, 2018. [9] M. Soriano-Amat, H. F. Martins, V. Duran, L. Costa, S. Martin-Lopez, M. Gonzalez-Herraez, and M. R. Fernandez-Ruiz, “Time-expanded phase-sensitive optical time-domain reflectometry,” Light: Science and Applications, vol. 10, no. 1, 2021.
[10] Y. Rao, Z. Wang, H. Wu, Z. Ran, and B. Han, “Recent Advances in Phase-Sensitive Optical Time Domain Reflectometry (φ-OTDR),” Photonic Sensors, vol. 11, no. 1, pp. 1-30, 2021.
[11] I. Lior, A. Sladen, D. Rivet, J. P. Ampuero, Y. Hello, C. Becerril, H. F. Martins, P. Lamare, C. Jestin, S. Tsagkli, and C. Markou, “On the Detection Capabilities of Underwater Distributed Acoustic Sensing,” Journal of Geophysical Research: Solid Earth, vol. 126, no. 3, pp. 1-20, 2021.
[12] J. O. Hammond, R. England, N. Rawlinson, A. Curtis, K. Sigloch, N. Harmon, and B. Baptie, “The future of passive seismic acquisition,” Astronomy and Geophysics, vol. 60, no. 2, pp. 37-42, 2019.
[13] E. F. Williams, M. R. Fernandez-Ruiz, R. Magalhaes, R. Vanthillo, Z. Zhan, M. González-Herraez, and H. F. Martins, “Distributed sensing of microseisms and teleseisms with submarine dark fibers,” Nature Communications, vol. 10, no. 1, pp. 1-11,
[14] M. R. Fernandez-Ruiz, H. F. Martins, E. Williams, C. Becerril, R. Magalhaes, L. D. Costa, S. Martin-Lopez, S. Jia, Z. Zhan, and M. GonzalezHerraez, “Seismic Monitoring with Distributed Acoustic Sensing from the Near-surface to the Deep Oceans,” Journal of Lightwave Technology, pp. 1-1, 2021.
[15] H. F. Martins, M. R. Fernandez-Ruiz, L. Costa, E. Williams, Z. Zhan, S. Martin-Lopez, and M. Gonzalez-Herraez, “Monitoring of remote seismic events in metropolitan area fibers using distributed acoustic sensing (DAS) and spatiotemporal signal processing,” in Optical Fiber Communication Conference (OFC) 2019. Optica Publishing Group, 2019, p. M2J.1
[16] J. Nuño, S. Martin-Lopez, J. D. Ania-Castañón, M. Gonzalez-Herraez, and H. F. Martins, “Virtual transparency in φ-OTDR using second order Raman amplification and pump modulation,” Opt. Express, vol. 29, no. 22, pp. 35725-35734, oct 2021.
[17] Q. Liu, X. Fan, and Z. He, “Time-gated digital optical frequency domain reflectometry with 1.6—m spatial resolution over entire 110—km range,” Optics Express, vol. 23, no. 20, pp. 3323-3328, 2015.
[18] D. Suetsugu and H. Shiobara, “Broadband ocean-bottom seismology,” Annual Review of Earth and Planetary Sciences, vol. 42, pp. 27-43, 2014.
[19] G. Marra, C. Clivati, R. Luckett, A. Tampellini, J. Kronjäger, L. Wright, A. Mura, F. Levi, S. Robinson, A. Xuereb, B. Baptie, and D. Calonico, “Ultrastable laser interferometry for earthquake detection with terrestrial and submarine cables,” Science, vol. 361, no. 6401, pp. 486-490, 2018.
[20] Z. Zhan, M. Cantono, V. Kamalov, A. Mecozzi, R. Müller, S. Yin, and J. C. Castellanos, “Optical polarization-based seismic and water wave sensing on transoceanic cables,” Science, vol. 371, no. 6532, pp. 931936, 2021.
[21] A. Mecozzi, M. Cantono, J. C. Castellanos, V. Kamalov, R. Muller, and Z. Zhan, “Polarization sensing using submarine optical cables,” Optica, vol. 8, no. 6, pp. 788-795, jun 2021
[22] Z. Jia, L. A. Campos, M. Xu, H. Zhang, M. Gonzalez-Herraez, H. F. Martins, and Z. Zhan, “Experimental Coexistence Investigation of Distributed Acoustic Sensing and Coherent Communication Systems,” in Optical Fiber Communication Conference (OFC) 2021. Optica Publishing Group, 2021, p. Th4F.4.
[23] P. J. Winzer, “Transmission system capacity scaling through spacedivision multiplexing: a techno-economic perspective,” 2020.
[24] B. J. Puttnam, G. Rademacher, and R. S. Luis, “Space-division multiplexing for optical fiber communications,” Optica, vol. 8, no. 9, pp. 1186-1203, sep 2021.
[25] K.-i. Kitayama and N.-P. Diamantopoulos, “Few-Mode Optical Fibers: Original Motivation and Recent Progress,’ IEEE Communications Magazine, vol. 55, no. 8, pp. 163-169, 2017
[26] K. Saitoh and S. Matsuo, “Multicore fiber technology,” Journal of Lightwave Technology, vol. 34, no. 1, pp. 55-66, jan 2016.
[27] R. Dar, P. J. Winzer, A. R. Chraplyvy, S. Zsigmond, K.-Y. Huang, H. Fevrier, and S. Grubb, “Cost-optimized submarine cables using massive spatial parallelism,” Journal of Lightwave Technology, vol. 36, no. 18, pp. 3855-3865, 2018
[28] A. Li, Y. Wang, Q. Hu, and W. Shieh, “Few-mode fiber based optical sensors,” Opt. Express, vol. 23, no. 2, pp. 1139-1150, jan 2015.
[29] I. Ashry, Y. Mao, A. Trichili, B. Wang, T. K. Ng, M.-S. Alouini, and B. S. Ooi, “A Review of Using Few-Mode Fibers for Optical Sensing,” IEEE Access, vol. 8, pp. 179 592-179605, 2020. [30] Z. Zhao and M. Tang, “Distributed fiber sensing using SDM fibers,” in 26th Optoelectronics and Communications Conference. Optica Publishing Group, 2021, p. W4D.1.
[31] Y. H. Kim and K. Y. Song, “Recent Progress in Distributed Brillouin Sensors Based on Few-Mode Optical Fibers,” Sensors, vol. 21, no. 6, p. 2168, 2021
[32] A. Li, Y. Wang, J. Fang, M.-J. Li, B. Y. Kim, and W. Shieh, “Fewmode fiber multi-parameter sensor with distributed temperature and strain discrimination.” Optics letters, vol. 40 7, pp. 1488-1491, 2015.
[33] Y. Mao, I. Ashry, M. S. Alias, T. K. Ng, F. Hveding, M. Arsalan, and B. S. Ooi, “Investigating the Performance of a Few-Mode Fiber for Distributed Acoustic Sensing,” IEEE Photonics Journal, vol. 11, no. 5, pp. 1-10, 2019.
[34] Y. Meng, C. Fu, C. Du, L. Chen, H. Zhong, P. Li, B. Xu, B. Du, J. He, and Y. Wang, “Shape Sensing Using Two Outer Cores of Multicore Fiber and Optical Frequency Domain Reflectometer,” Journal of Lightwave Technology, vol. 39, no. 20, pp. 6624-6630, 2021.
[35] Z. Zhao, M. Tang, L. Wang, N. Guo, H.-Y. Tam, and C. Lu, “Distributed Vibration Sensor Based on Space-Division Multiplexed Reflectometer and Interferometer in Multicore Fiber,” Journal of Lightwave Technology, vol. 36, no. 24, pp. 5764-5772, 2018.
[36] Z. Ding, C. Wang, K. Liu, J. Jiang, D. Yang, G. Pan, Z. Pu, and T. Liu, “Distributed Optical Fiber Sensors Based on Optical Frequency Domain Reflectometry: A review,” Sensors, vol. 18, no. 4, 2018.
[37] J. B. Murray, A. Cerjan, and B. Redding, “Distributed Brillouin fiber laser sensor,” Optica, vol. 9, no. 1, pp. 80-87, jan 2022.
[38] N. Kono, F. Ito, D. Iida, and T. Manabe, “Impulse response measurement of few-mode fiber systems by coherence-recovered linear optical sampling,” Journal of Lightwave Technology, vol. 35, no. 20, pp. 43924398, 2017.
[39] S. Rommel, J. M. D. Mendinueta, W. Klaus, J. Sakaguchi, J. J. V. Olmos, Y. Awaji, I. T. Monroy, and N. Wada, “Few-mode fiber, splice and SDM component characterization by spatially-diverse optical vector network analysis,” Optics Express, vol. 25, no. 19, p. 22347, 2017.
[40] N. K. Fontaine, “Characterization of space-division multiplexing fibers using swept-wavelength interferometry,” Optical Fiber Communication Conference, O F C 2015, vol. 1, no. c, pp. 4-6, 2015.
[41] R. Maruyama, N. Kuwaki, S. Matsuo, and M. Ohashi, “Relationship between Mode Coupling and Fiber Characteristics in Few-Mode Fibers Analyzed Using Impulse Response Measurements Technique,” Journal of Lightwave Technology, vol. 35, no. 4, pp. 650-657, 2017.
[42] J. Jia, J. Cui, J. Zhang, M. Zuo, Y. Gao, Z. Chen, Y. He, and J. Li, “Distributed vibration sensor based on mode coupling in weakly coupled few-mode fibers,” Opt. Lett., vol. 47, no. 7, pp. 1717-1720, Apr 2022.
[43] E. D. Moore, “Advances in swept-wavelength interferometry for precision measurements,” Ph.D. dissertation, University of Colorado at Boulder, 2011.
[44] A. E. Willner, H. Huang, Y. Yan, Y. Ren, N. Ahmed, G. Xie, C. Bao, L. Li, Y. Cao, Z. Zhao, J. Wang, M. P. J. Lavery, M. Tur, S. Ramachandran, A. F. Molisch, N. Ashrafi, and S. Ashrafi, “Optical communications using orbital angular momentum beams,” Adv. Opt. Photon., vol. 7, no. 1, pp. 66-106, mar 2015.
[45] Z. Wang, L. Zhang, S. Wang, N. Xue, F. Peng, M. Fan, W. Sun, X. Qian J. Rao, and Y. Rao, “Coherent φ-OTDR based on I/Q demodulation and homodyne detection,” Opt. Express, vol. 24, no. 2, pp. 853-858, jan 2016.
[46] X. Lu, M. A. Soto, L. Zhang, and L. Thévenaz, “Spectral Properties of the Signal in Phase-Sensitive Optical Time-Domain Reflectometry With Direct Detection,” J. Lightwave Technol., vol. 38, no. 6, pp. 1513-1521 Mar. 2020
[47] Y. Koyamada, M. Imahama, K. Kubota, and K. Hogari, “Fiber-optic distributed strain and temperature sensing with very high measurand resolution over long range using coherent OTDR,” Journal of Lightwave Technology, vol. 27, no. 9, pp. 1142-1146, 2009.
[48] F. Ito, X. Fan, and Y. Koshikiya, “Long-Range Coherent OFDR With Light Source Phase Noise Compensation,” Journal of Lightwave Technology, vol. 30, no. 8, pp. 1015-1024, 2012.
[49] L. Costa, H. F. Martins, S. Martin-Lopez, M. R. Fernandez-Ruiz, and M. Gonzalez-Herraez, “Fully Distributed Optical Fiber Strain Sensor with 10⁻¹²ε/\sqrt{ } Hz Sensitivity,” Journal of Lightwave Technology vol. 37, no. 18, pp. 4487-4495, 2019.
[50] L. Marcon, M. Soriano-Amat, R. Veronese, A. Garcia-Ruiz, M. Calabrese, L. Costa, M. R. Fernandez-Ruiz, H. F. Martins, L. Palmieri, and M. Gonzalez-Herraez, “Analysis of Disturbance-Induced “Virtual” Perturbations in Chirped Pulse φ-OTDR,” IEEE Photonics Technology Letters, vol. 32, no. 3, pp. 158-161, 2020. [51] M. R. Fernández-Ruiz, J. Pastor-Graells, H. F. Martins, A. GarciaRuiz, S. Martin-Lopez, and M. Gonzalez-Herraez, “Laser phase-noise cancellation in chirped-pulse distributed acoustic sensors,” Journal of Lightwave Technology, vol. 36, no. 4, pp. 979-985, 2018.
[52] L. Zhang, L. D. Costa, Z. Yang, M. A. Soto, M. Gonzalez-Herraez, and L. Thévenaz, “Analysis and reduction of large errors in rayleigh-based distributed sensor,” Journal of Lightwave Technology, vol. 37, no. 18, pp. 4710-4719, 2019.
[53] H. D. Bhatta, L. Costa, A. Garcia-Ruiz, M. R. Fernandez-Ruiz, H. F Martins, M. Tur, and M. Gonzalez-Herraez, “Dynamic Measurements of 1000 Microstrains Using Chirped-Pulse Phase-Sensitive Optical TimeDomain Reflectometry,’ J. Lightwave Technol., vol. 37, no. 18, pp. 48884895, Sep 2019.
[54] Further information on one or more embodiments of the present invention can be found in “Mode-Walk-off Interferometry for Position-Resolved Optical Fiber Sensing,” by Luis Costa, Zhongwen Zhan, and Alireza Marandi Journal of Lightwave Technology Vol. 41, issue 2, pp. 752-760 (2023) (including supplementary information) and
[55] Further information on one or more embodiments of the present invention can be found in https://arxiv.org/pdf/2203.16783.pdf https://doi.org/10.48550/arXiv.2203.16783

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

The present disclosure includes Appendix A, the entire contents of which is to incorporated herein for all purposes and is considered part of this disclosure.

1. A sensor system, comprising:
an optical fiber comprising a first spatial channel and a second spatial channel, wherein the spatial channels are coupled and electromagnetic radiation propagates with different group velocities in each of the spatial channels;
a source inputting the electromagnetic radiation into the first spatial channel at an input; and
a detection system coupled to an output of the fiber, the detection system comprising:
a detector detecting a transmission, from the input to the output, of the electromagnetic radiation coupled into the second spatial channel at different positions along the fiber between the input to the output, and generating a signal in response thereto; and
a computer processing the signal to obtain a localized measurement of a physical parameter at one or more of the different positions along the fiber.

2. The sensor system of claim 1, wherein the localized measurement comprises a quantitative measurement, the fiber comprises a step-index fiber, a graded-index few-mode fiber, a heterogeneous multicore fiber, or a coupled-core multicore fiber, and the spatial channels comprise co-propagating modes or cores having the different group velocities for the electromagnetic radiation.

3. The sensor system of claim 1 comprising a plurality of the fibers of claim 1 distributed in a network, wherein the spatial channels comprise spatial and wavelength multiplexed data channels.

4. The sensor system of claim 1, wherein the physical parameter comprises strain, temperature, birefringence, or refractive index of the fiber.

5. The sensor system of claim 1, further comprising a polarization synthesizer, wherein the source inputs the electromagnetic radiation via the polarization synthesizer and the physical parameter comprises at least one of a circular component or a linear component of birefringence.

6. The sensor of claim 1, wherein the computer:
identifies, in the signal, changes in a coupling strength between the spatial channels as a function of the different positions, and
processes the changes in the coupling strength to obtain the localized measurement of the physical parameter comprising at least one of transverse stress, a bending, or transverse pressure applied to the fiber.

7. The sensor system of claim 1, wherein the fiber is coupled to one or more in line amplifiers amplifying the electromagnetic radiation at one or more of different positions along a length of the fiber, so that the detection system measures the interference with increased signal to noise.

8. A telecommunications link comprising the sensor system of claim 1, comprising the fiber coupled to one or more non-reciprocal elements, wherein the non-reciprocal elements prevent backward propagation of the electromagnetic radiation in the fiber.

9. The sensor system of claim 1, wherein the computer:
processes the signal by:
sampling at a sampling rate to obtain sampled data, and
identifying interference or a change in coupling strength in the sampled data, the interference resulting from the electromagnetic radiation coupled into the second spatial channel at different positions along the fiber; and
wherein the sampling rate is selected independently of the round-trip time for propagation of the electromagnetic radiation between the input and the output.

10. The sensor system of claim 1, wherein:
the detector comprises balanced detectors detecting a local oscillator comprising the electromagnetic radiation outputted from the first spatial channel, and the electromagnetic radiation outputted from the second spatial channel, wherein the local oscillator and the electromagnetic radiation in the second mode are automatically path length matched by virtue of being carried in the same fiber and common mode noise is rejected using the local oscillator.

11. The sensor system of claim 1, wherein:
the source outputs the electromagnetic radiation comprising multiple center frequencies, and
the computer identifies the interference at each of the different positions by:
partitioning the signal into a plurality of sections, each of the sections comprising a frequency response of the fiber to a different one of the center frequencies, and
associating each of the frequency responses to a different one of the positions along a length the fiber; and
the computer obtains the localized measurement by comparing each of one or more of the frequency responses to a previously acquired reference.

12. The sensor of claim 11, wherein the comparing obtains a frequency detuning with respect to the reference and the computer calculates the localized measurement from the frequency detuning.

13. The sensor system of claim 11, further comprising an auxiliary interferometer coupled to the source, wherein:
the source inputs the electromagnetic radiation comprising a linear frequency sweep comprising the center frequencies to the auxiliary interferometer and the fiber;
the auxiliary interferometer outputs an auxiliary signal and the computer uses the auxiliary signal to determine a nonlinearity of the frequency sweep; and
the computer adjusts the frequency responses to account for the nonlinearity.

14. The sensor system of claim 11, wherein the source outputs chirped pulses comprising the plurality of center frequencies or a plurality of shots of the electromagnetic radiation each comprising a different one of the center frequencies.

15. The sensor system of claim 1, wherein the computer:
processes the signal so as to identify one or more phase differences in the signal resulting from interference between the electromagnetic radiation coupled into the second spatial channel at the different positions of strong coupling between the spatial channels, and
processes the phase differences to obtain the localized measurements.

16. The sensor system of claim 15, wherein the physical parameters comprise inter-mode coupling at the different positions of components coupled to the fiber, the different components comprising at least one of an amplification stage, a splice, a connector, a multiplexer, or a demultiplexer.

17. The sensor system of claim 1, further comprising a second detection system measuring backwards propagation of the electromagnetic radiation resulting from reflection or backscattering events of the electromagnetic radiation towards the input, wherein the computer determines the physical parameters with denser spatial sampling in-between the reflection or backscattering events.

18. The sensor system of claim 1, further comprising a second detection system measuring backwards propagation of the electromagnetic radiation resulting from reflection or backscattering events towards the input, wherein the computer uses a simultaneous measurement of the backwards propagation from the second detection system to isolate a contribution of the physical parameter comprising a circular component of the birefringence vector.

19. The sensor system of claim 1, wherein:
the fiber transmits the electromagnetic radiation modulated according to a space-division multiplexing scheme, and
the computer:
processes the signal so as to identify changes in a coupling strength between the spatial channels as a function of the different positions, and
processes the changes in the coupling strength to obtain the localized measurement of the physical parameter.

20. The sensor system of claim 1, wherein the computer compares changes in the interference and the coupling strength between the spatial channels comprising multiple higher order copropagating modes of the electromagnetic radiation, so as to obtain the local measurements of a plurality of the physical parameters, resulting from a perturbation of the fiber, with reduced cross-sensitivity between parameters.

21. A computer implemented method of sensing, comprising:
receiving, in a computer, a signal formed in response to:
inputting electromagnetic radiation into a first spatial channel of an optical fiber comprising the first spatial channel and a second spatial channel, wherein the spatial channels are weakly coupled and electromagnetic radiation propagates with different group velocities in each of the spatial channels;
detecting a transmission, from the input to the output, of the electromagnetic radiation coupled into the second spatial channel at different positions along the fiber between the input to the output, and generating the signal in response thereto; and
processing the signal to obtain a localized measurement of a physical parameter at one or more of the different positions along the fiber.
